(19) United States
(12) Patent Application Publication
(10) Pub. No.: US 2026/0361477 A1
(43) Pub. Date: Nov. 12, 2026

(54) TECHNOLOGIES FOR TRANSMISSION CONFIGURATION INDICATOR ASSOCIATION FOR PHYSICAL DOWNLINK SHARED CHANNEL RECEPTION

(71) Applicant: Apple Inc., Cupertino, CA (US)

(72) Inventors: Hong He, San Jose, CA (US); Chunhai Yao, Beijing (CN); Sigen Ye, San Diego, CA (US); Weidong Yang, San Diego, CA (US); Dawei Zhang, Saratoga, CA (US); Wei Zeng, Saratoga, CA (US); Jie Cui, San Jose, CA (US); Chunxuan Ye, San Diego, CA (US); Huaning Niu, San Jose, CA (US)

(73) Assignee: Apple Inc., Cupertino, CA (US)

(21) Appl. No.: 19/125,714

(22) PCT Filed: Nov. 3, 2022
(86) PCT No.: PCT/CN2022/129574

§ 371 Date: Apr. 29, 2025

(51) Int. Cl. H04L 5/00; H04L 27/26

(52) U.S. Cl. CPC H04L 5/0044; H04L 27/26025

(57) ABSTRACT

The present application relates to devices and components including apparatuses, systems, and methods for transmission configuration indicator association for physical downlink shared channel reception.

### TECHNICAL FIELD

This application relates generally to communication networks and, in particular, to technologies for technologies for transmission configuration indicator association for physical downlink shared channel reception.

### BACKGROUND

A user equipment (UE) may be connected with a network through multiple transmit/receive points (TRPs). In multi-TRP (mTRP) transmission, different TRPs may provide different data for spatial multiplexing or the same data to improve robustness. Multi-TRP may be supported by a single-downlink control information (DCI) mode and multi-DCI mode. In single-DCI (sDCI) mode, one TRP sends DCI to schedule PDSCH transmissions from more than one TRP. In multi-DCI (mDCI) mode, TRPs may independently schedule their own PDSCH.

### BRIEF DESCRIPTION OF THE DRAWINGS

FIG. 1 illustrates a network environment in accordance with some embodiments.

FIG. 2 illustrates a codepoint setting in accordance with some embodiments.

FIG. 3 illustrates media access control (MAC) control element (CE) in accordance with some embodiments.

FIG. 4 illustrates a pair of transmission configuration indicator (TCI)-state lists and DCI in accordance with some embodiments.

FIG. 5 illustrates another pair of TCI-state lists and DCI in accordance with some embodiments.

FIG. 6 illustrates another pair of TCI-state lists and DCI in accordance with some embodiments.

FIG. 7 illustrates DCI in accordance with some embodiments.

FIG. 8 illustrates an example operation for updating TCI states in accordance with some embodiments.

FIG. 9 illustrates another example operation for updating TCI states in accordance with some embodiments.

FIG. 10 illustrates a signaling diagram in accordance with some embodiments.

FIG. 11 illustrates an operational flow/algorithmic structure in accordance with some embodiments.

FIG. 12 another operational flow/algorithmic structure in accordance with some embodiments.

FIG. 13 illustrates another operational flow/algorithmic structure in accordance with some embodiments.

FIG. 14 illustrates an user equipment in accordance with some embodiments.

FIG. 15 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

The term “multi-” as used herein refers to more than one.

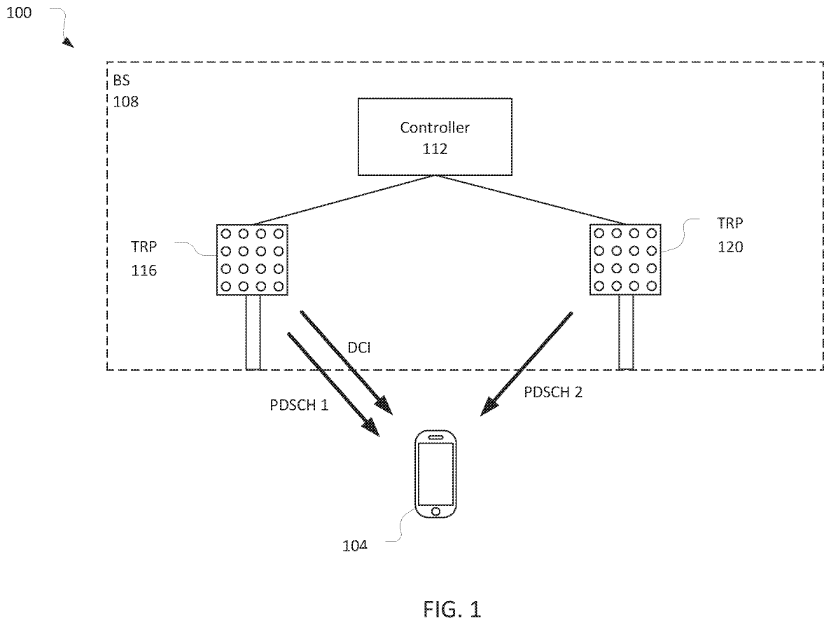

FIG. 1 illustrates a network environment 100 in accordance with some embodiments. The network environment 100 may include a UE 104 and a base station (BS) 108. The base station 108 may provide one or more wireless access cells, for example, Third Generation Partnership Project (3GPP) New Radio (NR) cells, through which the UE 104 may communicate with the base station 108. The UE 104 and the base station 108 may communicate over an air interface compatible with 3GPP technical specifications such as those that define Fifth Generation (5G) NR or later generation system standards.

The base station 108 may include a controller 112 coupled with one or more TRPs, for example, TRP 116 and TRP 120. In general, the controller 112 may perform the majority of the operations of a communication protocol stack, including scheduling, while the TRPs 116 and 120 act as distributed antennas. In some embodiments, the TRPs 116 and 120 may perform some lower-level operations of the communication protocol stack (for example, analog physical (PHY) layer operations). While FIG. 1 shows the TRPs 116 and 120 as part of the base station 108, in other embodiments, the TRPs 116 and 120 may be associated with different base stations.

The base station 108 may use the TRPs 116 and 122 to geographically separate points at which a signal may be transmitted to, or received from, the UE 104. This may increase flexibility of using multiple-input, multiple-output (MIMO) and beamforming enhancements for communicating with the UE 104. The TRPs 116 and 120 may be used to transmit the same or different downlink transmissions to the UE 104. In some embodiments, the distributed transmit/receive capabilities provided by the TRPs 116 and 120 may be used for coordinated multipoint or carrier aggregation systems.

In sDCI mode, DCI transmitted by a single TRP, for example, TRP 116, may schedule physical downlink shared channel (PDSCH) transmissions from a plurality of TRPs, for example TRP 116 and TRP 120. The DCI may schedule a PDSCH transmission by indicating a PDSCH transmission occasion in which the PDSCH may be transmitted. As shown in FIG. 1, TRP 116 is to transmit a first PDSCH transmission (PDSCH 1), and TRP 120 is to transmit a second PDSCH transmission (PDSCH 2) in respective PDSCH transmission occasions. In various embodiments, PDSCH 1 and PDSCH 2 may include the same or different information.

Transmissions that use different antenna ports may experience different radio channels. However, in some situations, different antenna ports may share common radio channel characteristics. For example, different antenna ports may have similar Doppler shifts, Doppler spreads, average delay, delay spread, or spatial receive parameters (for example, properties associated with a downlink received signal angle of arrival at a UE). Antenna ports that share one or more of these large-scale radio channel characteristics may be said to be quasi co-located with one another. 3GPP has specified four types of quasi co-location (QCL) to indicate which particular channel characteristics are shared. In QCL Type A, antenna ports share Doppler shift, Doppler spread, average delay, and delay spread. In QCL Type B, antenna ports share Doppler shift and Doppler spread are shared. In QCL Type C, antenna ports share Doppler shift and average delay. In QCL Type D, antenna ports share spatial receiver parameters.

The base station 108 may provide transmission configuration indicator (TCI) state information to the UE 104 to indicate QCL relationships between antenna ports used for reference signals (for example, synchronization signal/physical broadcast channel (PBCH) or channel state information-reference signal (CSI-RS)) and downlink data or control signaling, for example, PDSCH or physical downlink control channel (PDCCH). The base station 108 may use a combination of radio resource control (RRC) signaling, MAC CE signaling, and DCI, to inform the UE 104 of these QCL relationships.

Initially, the base station 108 may configure the UE 104 with a plurality of TCI states through RRC signaling. In some embodiments, up to 128 TCI states may be configured for PDSCH through, for example, a PDSCH-config information element, and up to 64 TCI states may be configured for PDCCH through, for example, a PDCCH-config information element. Each TCI state may include a cell identifier, a bandwidth part identifier, an indication of the relevant SS/PBCH block or CSI-RS, and an indication of the QCL type. The TCI states may be set as inactive after initial configuration.

The base station 108 may then transmit an activation command through, for example, a MAC CE. The activation command may activate up to eight combinations of TCI states that correspond to eight codepoints of a TCI codepoint field in DCI. One or more specific TCI states may then be dynamically selected and signaled using the TCI codepoint field in DCI to indicate which of the active TCI states are applicable to a PDSCH resource allocation.

The initial state framework of 3GPP Release 15 provided that TCI states were separately indicated for different DL channels (e.g., PDSCH and PDCCH), which may result in the different DL channels using different active TCI states. While this provided significant flexibility, it was also associated with a large signaling overhead. Release 17 of 3GPP developed a unified TCI framework to facilitate streamlined multi-beam operation targeting higher frequency ranges, for example, frequency range 2 (FR2) from 24,250 megahertz (MHz) to 71,000 MHz. With unified TCI, a single active TCI state may be used as a unified downlink TCI state to be applied for all PDSCH/PDCCH channels. A unified uplink TCI state may also be defined/applied for uplink channels (e.g., physical uplink shared channel (PUSCH) and physical uplink control channel (PUCCH).

The Release 17 unified TCI framework focuses on sTRP use cases. Extension of the unified TCI framework to mTRP use cases may be beneficial. To accommodate a unified TCI framework for mTRP, up to four TCI states may be indicated in a component carrier (CC)/bandwidth part (BWP) or a set of CCs/BWPs in a CC list. The up to four TCI states, which may be used for DL receptions or UL transmissions, may be indicated/updated by a MAC CE or DCI with MAC CE based TCI state activation.

Embodiments of the present disclosure address various issues in order to ensure flexibility of unified TCI states indication for mTRP.

In a first issue, embodiments describe how to indicate the TCI-state update by the DCI format for two TRPs. For example, the TCI codepoint field in DCI may include three-bits, which supports eight combinations of TCI states with each combination being associated with a codepoint of the TCI codepoint field. Each combination can include up to four TCI states, e.g., TCI state #1, TCI state #2, TCI state #3, and TCI state #4. Thus, support for up to 8*8*8*8=4096 combinations would be required for support of up to eight candidates with full flexibility. This would require a 12-bit indication. Embodiments describe how to use the 3-bit TCI codepoint field to efficiently update 4,096 TCI state combinations for m TRPs (for example, two TRPs).

In a second issue, embodiments describe how to associate two indicated downlink TCI states by TCI codepoint with a PDSCH reception in sDCI mTRP.

Various aspects may be considered for indicating up to four unified TCI states for sDCI mTRP operation.

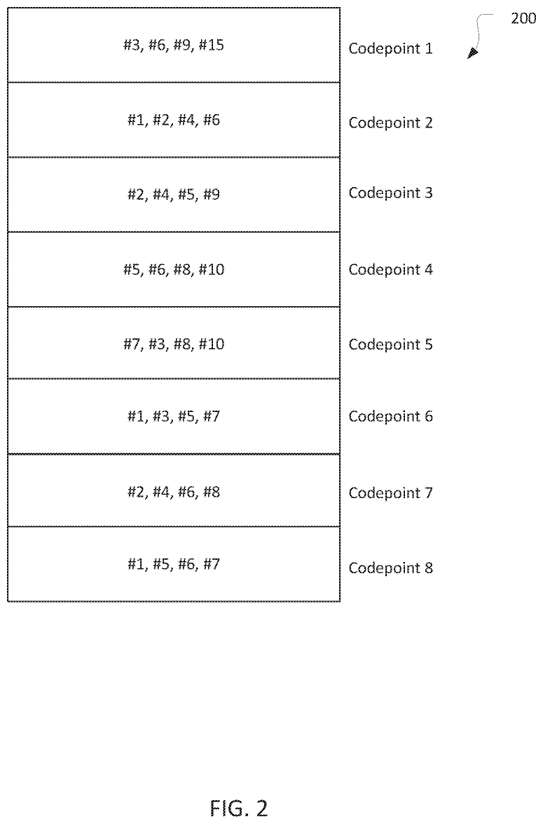

In a first aspect, each TCI codepoint in DCI may always be associated with four TCI states. FIG. 2 illustrates an example codepoint setting 200 in accordance with the first aspect. The codepoint setting 200 may include eight codepoints, which may be indicated through a 3-bit TCI codepoint field in DCI. Each of the eight codepoints may be associated with different combinations of four TCI states. The four TCI states of the codepoints may correspond to two uplink TCI states and two downlink TCI states. For example, the four TCI states may respectively correspond to a DL state #1 (e.g., TCI state the UE 104 is to use to receive downlink transmissions from TRP #1), an UL state #1 (e.g., TCI state the UE 104 is to use to transmit uplink transmissions to TRP #1), DL state #2 (e.g., TCI state the UE 104 is to use to receive downlink transmissions from TRP #2), and an UL state #2 (e.g., TCI state the UE 104 is to use to transmit uplink transmissions to TRP #2). Thus, if the UE 104 receives a DCI with a TCI codepoint field set to ‘101,’ codepoint 5 would be indicated. The UE 104 may then determine it is to use TCI states #7, #3, #8, #10 for DL state #1, UL state #1, DL state #2, and UL state #2, respectively.

A second aspect for providing a unified TCI state indication for sDCI mTRP may rely on TRP-specific activated TCI-state lists. In the second aspect, MAC CEs may be used for TRP-specific TCI state activation followed by unified TCI states indication for multiple TRPs.

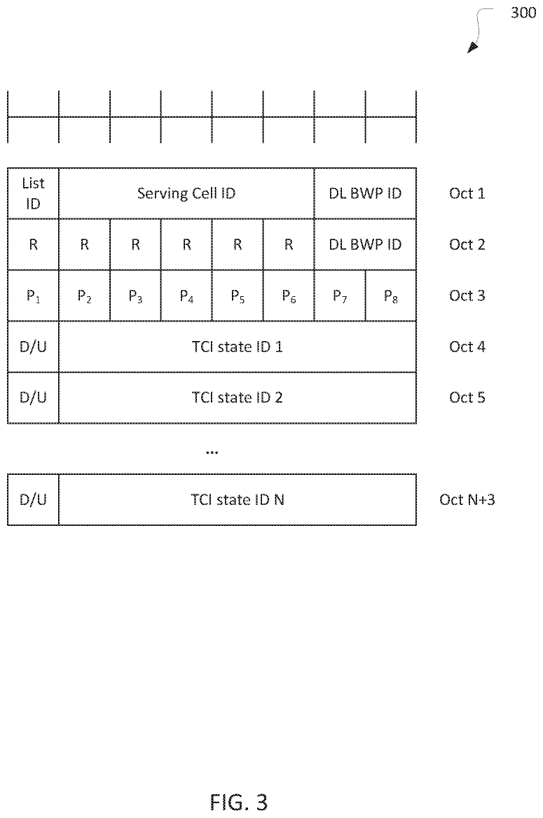

FIG. 3 illustrates a MAC CE 300 that may be used to activate/deactivate TCI states of a TCI-state list that is specific to a TRP in accordance with some embodiments.

In a first octet, the MAC CE 300 may include a 1-bit field to indicate a list identifier (ID) that provides an indication of whether the MAC CE 300 applies to a first TCI-state list or a second TCI-state list. In some embodiments, the list ID may be referred to with other names such as virtual ID, set ID, TRP ID, etc.

The first octet may further include a 5-bit field for a serving cell ID and a 2-bit field for DL BWP ID to respectively indicate identities of the serving cell and DL BWP to which the MAC CE applies.

In a second octet, the MAC CE 300 may include a number of reserved fields, marked as “R,” and may include a 2-bit field for UL BWP ID to indicate an identity of an UL BWP to which the MAC CE applies.

The Pᵢ fields of the third octet may be used to indicate whether each TCI codepoint has multiple TCI states or a single TCI state. For example, if the P₂ field is set to 1, the second TCI codepoint includes multiple TCI states.

Octet 4 through octet N+3 respectively configure TCI state IDs 1-N. The D/U field may be used to indicate whether the TCI state ID in the same octet is for joint/downlink or uplink TCI state. If the field is set to 1, the TCI state ID is for joint/downlink.

By using MAC CEs with list IDs, such as MAC CE 300, up to two lists may be created. More lists may be created if additional bits are used for the list ID. Each element in a list may include a TCI state for a joint/downlink state, an UL state, or both.

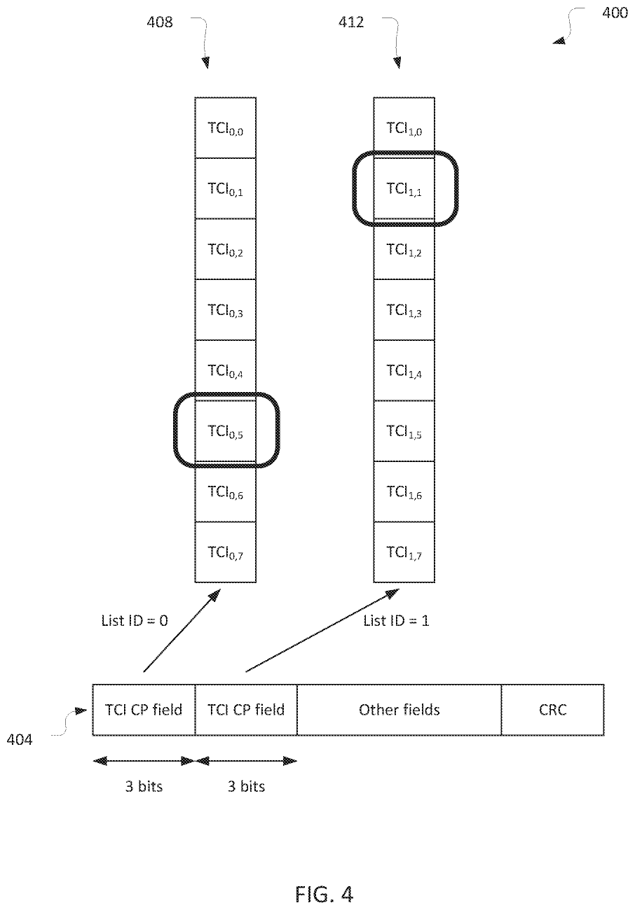

FIG. 4 illustrates a pair of TCI-state lists 400 and DCI 404 that may be used in unified TCI-state indication for multiple TRPs in accordance with some embodiments. The pair of TCI-state lists 400 may include a first TCI-state list 408 and a second TCI-state list 412.

The first TCI-state list 408 may include eight TCI state sets that respectively correspond to eight TCI codepoints. Each TCI state set may include one or more TCI states.

The eight TCI state sets of the first TCI-state list 408 may be activated by a MAC CE with a first list ID, for example, list ID=0. Similarly, the second TCI-state list 412 may include eight TCI state sets that respectively correspond to eight TCI codepoints. The eight TCI state sets of the second TCI-state list 408 may be activated by a MAC CE with a second list ID, for example, list ID=1. In some embodiments, the first TCI-state list 408 may correspond to a first TRP (e.g., TRP 116) while the second TCI-state list corresponds to a second TRP (e.g., TRP 120).

The DCI 404 may include two 3-bit TCI codepoint fields, a number of other fields, and a cyclic redundancy check (CRC) field. The first 3-bit TCI codepoint field may correspond to the first TCI-state list 408 (e.g., list ID=0). For example, the first 3-bit TCI codepoint field may be set with a value of ‘101’ to indicate that the TCI state set of the fifth TCI codepoint is to be used as the unified TCI state(s) for the first TRP. The second 3-bit TCI codepoint field may correspond to the second TCI-state list 412 (e.g., list ID=1). For example, the second 3-bit TCI codepoint field may be set with a value of ‘001’ to indicate that the TCI state set of the second TCI codepoint is to be used as the unified TCI state(s) for the second TRP.

In some designs, in order to avoid increasing the DCI size, use of two 3-bit TCI codepoint fields (as shown in DCI 404) may be limited to DCI format 1_1/1_2 without data scheduling. This may be done by repurposing the previously-reserved fields of DCI format 1_1/1_2 as the second TCI codepoint field.

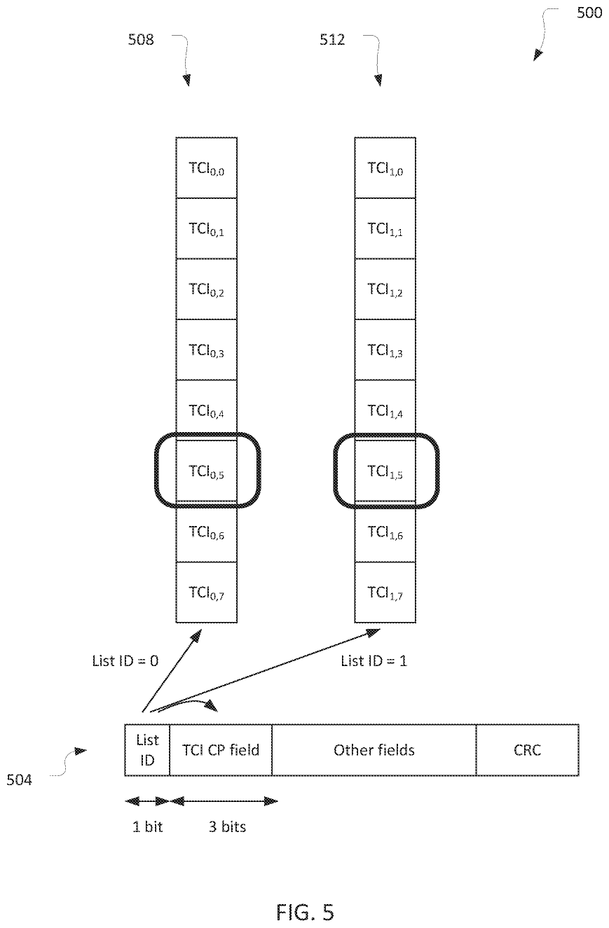

FIG. 5 illustrates a pair of TCI-state lists 500 and DCI 504 that may be used in unified TCI-state indication for multiple TRPs in accordance with some embodiments. The pair of TCI-state lists 500 may include a first TCI-state list 508 and a second TCI-state list 512.

The first TCI-state list 508 and the second TCI-state list 512 may be activated in a manner similar to that discussed above with respect to FIGS. 3 and 4.

The DCI 504 may include a 1-bit list ID field, a 3-bit TCI codepoint field, a number of other fields, and a CRC field. The 1-bit list ID field may be used to indicate whether the TCI state(s) indicated by the TCI codepoint field applies to the first TCI-state list 508 or the second TCI-state list 512. For example, if the 1-bit list ID field is set to ‘0’ and the TCI codepoint field is set to ‘101,’ the UE 104 may determine that the fifth TCI codepoint is to be used as the unified TCI state(s) for the first TRP only. Conversely, if the 1-bit list ID field is set to ‘l’ and the TCI codepoint field is set to ‘101,’ the UE 104 may determine that the fifth TCI codepoint is to be used as the unified TCI state(s) for the second TRP only.

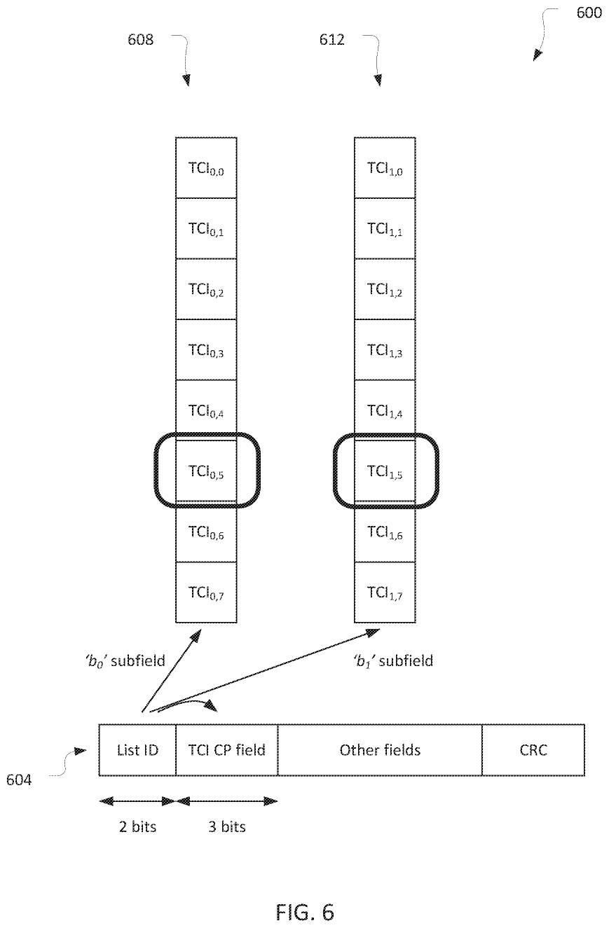

FIG. 6 illustrates a pair of TCI-state lists 600 and DCI 604 that may be used in unified TCI-state indication for multiple TRPs in accordance with some embodiments. The pair of TCI-state lists 600 may include a first TCI-state list 608 and a second TCI-state list 612.

The first TCI-state list 608 and the second TCI-state list 612 may be activated in a manner similar to that discussed above with respect to FIGS. 3 and 4.

The DCI 604 may include a 2-bit list ID field, a 3-bit TCI codepoint field, a number of other fields, and a CRC field. The 2-bit list ID field may be used to indicate whether the TCI state(s) indicated by the TCI codepoint field applies to the first TCI-state list 508 or the second TCI-state list 512. For example, a first bit (b₀) of the 2-bit list ID field may be set to indicate whether the TCI state(s) indicated by the TCI codepoint field applies to the first TRP and a second bit (b₀) of the 2-bit list ID field may be set to indicate whether the TCI state(s) indicated by the TCI codepoint field applies to the second TRP. If the bᵢ is set to ‘1’ then the indicated TCI state(s) apply to the respective TRP and if the bᵢ is set to ‘0’ then the indicated TCI state(s) do not apply to the respective TRP. For example, if the TCI codepoint field is set to ‘101’ and both b₀ and by are set to ‘1,’ the UE 104 may determine that the TCI_{1,5} applies to the first TRP and TCI_{1,5} applies to the second TRP.

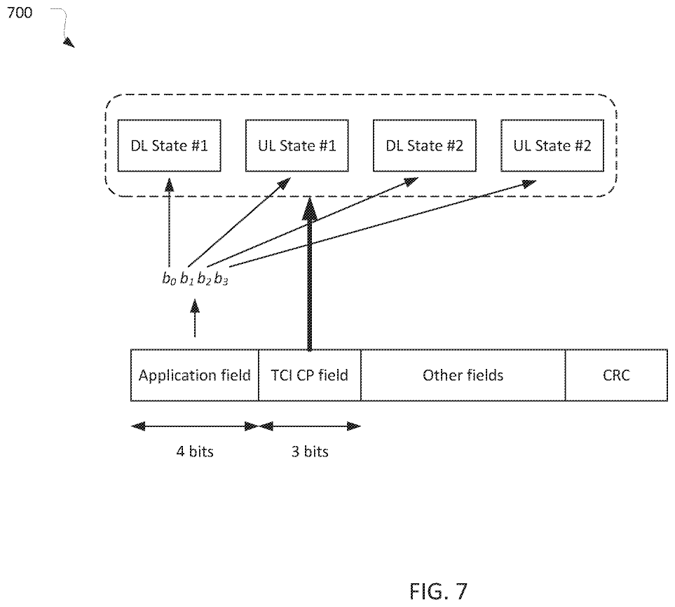

FIG. 7 illustrates a DCI 700 utilizing a bitmap-based TCI-state application indication in accordance with some embodiments. In some embodiment, the DCI 700 may have DCI format 1_1/1_2 with or without scheduling.

The maximum number of TCI states that may be associated with a TCI codepoint by an activation/deactivation MAC CE may be M. In some embodiments, M=4. When four TCI states are associated with a TCI codepoint, they may correspond to DL/UL TCI states 704. For example, the four TCI states may respectively correspond to a DL state #1, an UL state #1, a DL state #2, and an UL state #2.

The DCI 700 may include an application field, a TCI codepoint field, one or more other fields, and a CRC field. The application field may include a bitmap to provide an indication of whether TCI state(s) indicated by the TCI codepoint field apply to the various DL/UL TCI states 704. Each bit of the bitmap may be associated with an indicated TCI state of the TCI codepoint field. For example, if M=4 and the application field includes a 4-bit bitmap, ‘b₀b₁b₂b₃,’ each of the bits may be one-to-one mapped with each of the four TCI states to indicate whether the indicated TCI states by the TCI codepoint field is updated or not. If bᵢ=0, the associated TCI state is not applied. If bₜ=1, the associated TCI state is applied.

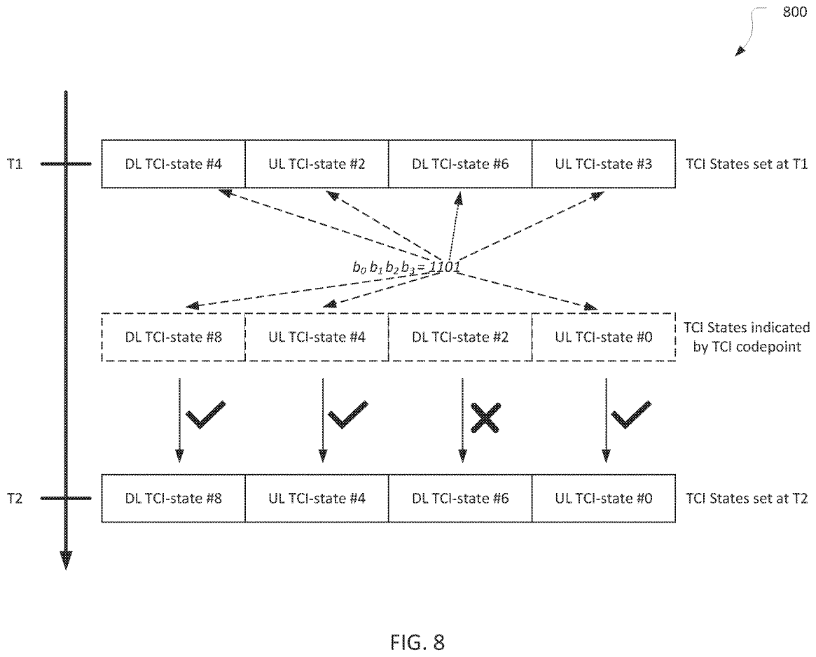

FIG. 8 illustrates an example operation 800 for updating TCI states based on a bitmap-based TCI state indication in accordance with some embodiments. At a first time period, T1, the UE 104 may be configured with a DL TCI state #4, an UL TCI-state #2, a DL TCI-state #6, and an UL TCI-state #3.

As part of the operation 800, the UE 104 may receive DCI (e.g., DCI 700) with an application field set to ‘1101’ and a TCI codepoint value that indicates a TCI codepoint with TCI states #8, #4, #2, and #0. Based on the values of the application field, the UE 104 may determine that the first, second, and fourth TCI states are to be updated based on the TCI states indicated by the TCI codepoint. For example, the UE 104 may update the first DL TCI state to TCI state #8, the first UL TCI state to TCI state #4, and the second UL TCI state to TCI state #0 based on corresponding indicated TCI states. However, the second DL TCI state may not be updated, due to the b₂ bit being set to ‘0,’ and that TCI state may remain as what it was at T1 (e.g., TCI state #6). Thus, the operation 800 may result in setting a combination of TCI states (e.g., #8, #4, #6, and #0) that may not even be associated with one TCI codepoint.

While the above example corresponds to an instance in which the TCI codepoint is associated with four TCI states, in other embodiments, the application field may be used to update TCI states when the TCI codepoint is associated with less than four TCI states. For example, if TCI codepoint is only associated with one TCI state, e.g., TCI state #9, and the bitmap of the application field includes a value of 1101, then the UE 104 may update the DL state #1, UL state #1, and UL state #2 to TCI state #9 and may leave the DL state #2 unchanged.

In some embodiments, using a bitmap-based TCI state application indication, as shown and described with respect to FIG. 7, may be applied when TRP-specific activation lists are created by a MAC CE as described with respect to FIGS. 3, 4, 5, and 6.

In some embodiments, a 2-bit application field may be used in DCI format 1_1/1_2 to provide the bitmap-based TCI-state application indication. In these embodiments, a first bit of the application field, b₀, may be used to indicate whether a first set of one or more TCI states are applied or not, while a second bit of the application field, b₁, may be used to indicate whether a second set of one or more TCI states are applied or not. The TCI state(s) may not be applied if bᵢ=0 and the TCI state(s) may be applied if bᵢ=1.

In some embodiments, the mapping of the 2-bit application field to the indicated TCI state(s) may be provided by Table 1 or Table 2 below.

TABLE 1

| Bit within | |
|---|---|
| application field | Indicated TCI states |
| b₀ | First and third (e.g., odd indexing) |
| b₁ | Second and fourth (e.g., even indexing) |

TABLE 2

| Bit within | |
|---|---|
| application field | Indicated TCI states |
| b₀ | First and second (e.g., first consecutive set |
| | indexing) |
| b₁ | Third and fourth (e.g., second consecutive |
| | set indexing) |

While both Tables 1 and 2 map two indicated TCI states to each bit of the application field, in other embodiments other mappings may be used. For example, the first bit may be mapped to the first indicated state while the second bit is mapped to the last three indicated states.

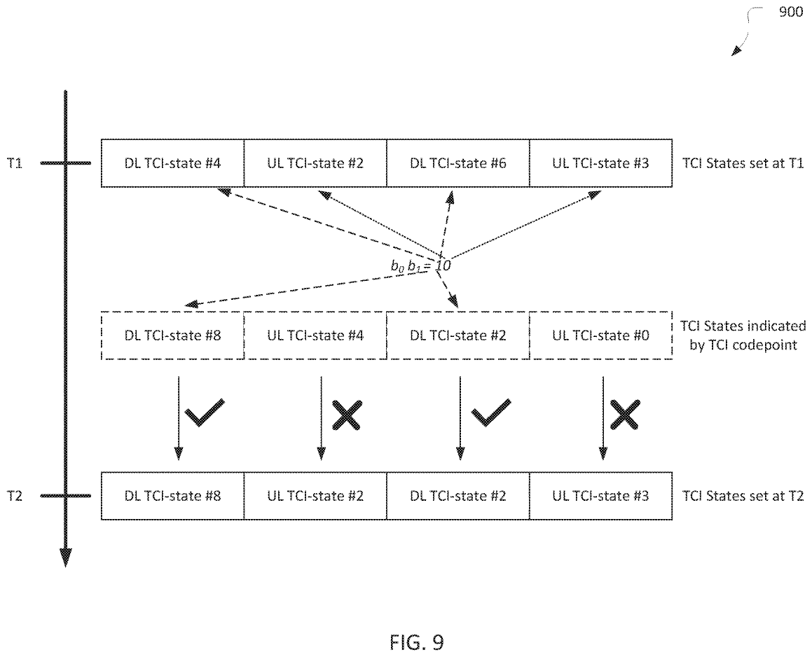

FIG. 9 illustrates an example operation 900 for updating TCI states based on a bitmap-based TCI state indication in accordance with some embodiments. In particular, the operation 900 may correspond to use of a two-bit application field and a mapping corresponding to Table 1.

At a first time period, T1, the UE 104 may be configured with a DL TCI state #4, an UL TCI-state #2, a DL TCI-state #6, and an UL TCI-state #3.

As part of the operation 900, the UE 104 may receive DCI with a 2-bit application field set to ‘10’ and a TCI codepoint value that indicates a TCI codepoint with TCI states #8, #4, #2, and #0. Based on the values of the application field, and with reference to Table 1, the UE 104 may determine that the first and third TCI states are to be updated based on the TCI states indicated by the TCI codepoint. For example, the UE 104 may update the first DL TCI state to TCI state #8 and the second DL TCI state to TCI state #2. However, the UE 104 may determine that the second and fourth TCI states are not to be updated, due to the by bit being set to ‘0,’ and those TCI states may remain what they were at T1 (e.g., TCI states #2 and #3).

Another aspect of the disclosure may provide for TCI association for PDSCH with sDCI-based mTRP. A variety of signaling approaches may be considered for sDCI-based m TRP to determine applied TCI states, assuming two unified joint/DL TCI states are indicated by a TCI codepoint in DCI format separately. The following four options describe some of the signaling approaches. Some of these options may be used with others. For example, they are not mutually exclusive.

In a first option, an RRC parameter may explicitly indicate which of the two indicated TCI states is to be used for PDSCH reception. For example, the RRC parameter may indicate the first TCI state is to be used for the PDSCH reception, the second TCI state is to be used for the PDSCH reception, or both the first and second TCI states are to be used for the PDSCH reception. The RRC parameter may be provided in each control resource set (CORESET) configuration or in each PDSCH configuration. The RRC parameter may configure the TCI state(s) to be used on a per bandwidth part (BWP) basis.

A second option may correspond to an instance in which a time offset between a scheduling DCI and a first symbol of the scheduled PDSCH is smaller than a predetermined threshold window. The predetermined threshold window may be referred to as a time duration for QCL (timeDurationForQCL), which may correspond to an amount of time the UE needs to decode the DCI and, potentially, return RF circuitry based on the TCI state(s) indicated by the DCI before receiving a PDSCH based on the updated TCI state(s). In some embodiments, the UE 104 may provide the base station 108 an indication of the value of timeDurationForQCL as part of a UE capability report. This may be provided on a per subcarrier spacing (SCS) basis.

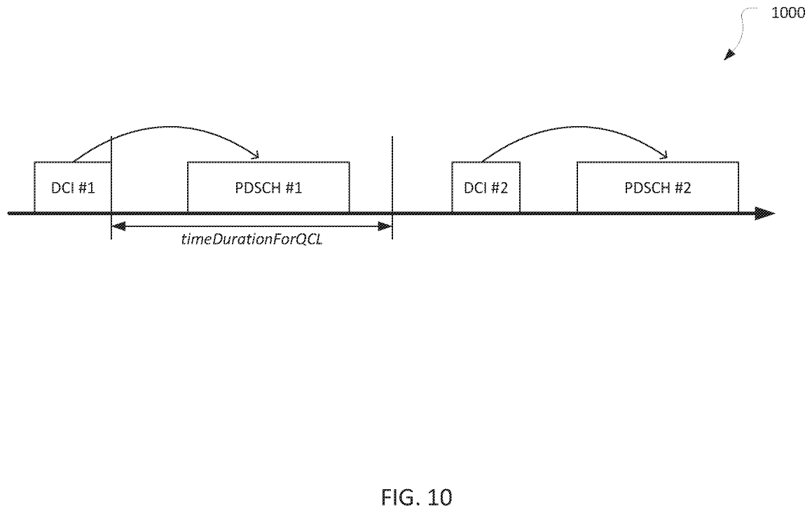

FIG. 10 is a signaling diagram 1000 illustrating the timeDurationForQCL in accordance with some embodiments. The signaling diagram 1000 includes a first DCI (DCI #1) that schedules a first PDSCH transmission (PDSCH #1) and a second DCI (DCI #2) that schedules a second PDSCH transmission (PDSCH #2). The timeDurationForQCL window may start after the last symbol of the PDCCH used to transmit the DCI.

As shown, the PDSCH #1 is received within the timeDurationForOCL window that follows the DCI #1. According to the second option, the UE 104 may determine default TCI state(s) that it may use to receive PDSCH #1 based on a fixed rule (for example, the first TCI state or the second TCI state is always used as the default TCI state) or based on the first option (for example, according to the RRC parameter of a CORESET/PDSCH configuration).

In some embodiments of the second option, the default TCI state may be the QCL assumption of the lowest CORESET ID in the latest monitored slot. In a case of carrier aggregation (CA), the lowest CC index may be selected. In this manner, the last TCI state(s) used to monitor PDCCH before receipt of the PDSCH may also be used as the default TCI state(s) for the PDSCH transmission.

In the event the gap between the scheduling DCI and the scheduled PDSCH transmission is greater than the timeDurationForQCL, the UE 104 may use the TCI states indicated by the TCI codepoint field for the reception of the PDSCH transmission.

In some embodiments, the base station 108 may provide instructions to the UE 104, through RRC signaling, for example, as to whether the UE 104 is to use the first option or the second option. Additionally/alternatively, one of the options (either the first or the second option) may be defined as a default mode and applied unless the other option is explicitly configured.

In a third option, the UE 104 may assume the TCI state indicated by a TCI codepoint field in scheduling DCI is to be applied to PDSCH transmissions received after timeDurationForOCL duration from an ending symbol of the PDCCH that carries the DCI. With reference to FIG. 10, consider that the TCI codepoint field in DCI #1 indicates TCI state #2. As discussed above, DCI #1 schedules PDSCH #1; however, PDSCH #1 is within the timeDurationForQCL window. Thus, the UE 104 is unable to apply TCI state #2 to PDSCH #1. Nevertheless, the UE 104 may still update its receive beam based on TCI state #2. In this manner, TCI state #2 may be applied for PDSCH transmissions received after the timeDurationForOCL window, for example, PDSCH #2 (in the event PDSCH #2 is received within the timeDurationForQCL window of DCI #2 and the UE 104 is unable to use whatever TCI state is indicated in DCI #2).

In a fourth option, the indicated TCI states by the TCI codepoint in DCI format may be applied as default beam to PDSCH transmissions within a timeDurationForQCL duration from an ending symbol of the PDCCH that carries the DCI.

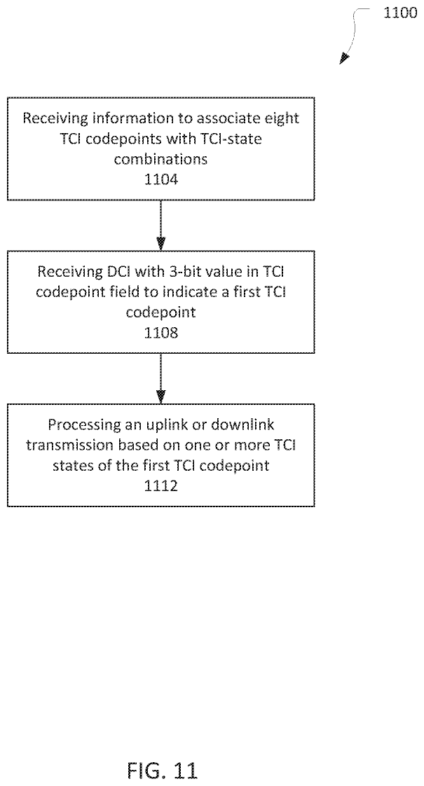

FIG. 11 illustrates an operation flow/algorithmic structure 1100 in accordance with some embodiments. The operation flow/algorithmic structure 1100 may be implemented by a UE (for example, UE 104) or 1400 or components therein, for example, processors 1404.

The operation flow/algorithmic structure 1100 may include, at 1104, receiving information to associate eight TCI codepoints with respective combinations of four TCI states. In some embodiments, the configuration information may be received in a MAC CE transmitted from a base station that activates/deactivates the TCI states associated with a particular TCI codepoint.

In some embodiments, the four TCI states may correspond to a first DL TCI state associated with a first TRP, a first UL TCI state associated with the first TRP, a second DL TCI state associated with a second TRP, and a second UL TCI state associated with the second TRP. The TCI states may be unified states. For example, the first DL TCI state may be used for both PDSCH and PDCCH transmissions from the first TRP, the first UL TCI state may be used for both PUSCH and PUCCH transmissions to the first TRP, and so on.

The operation flow/algorithmic structure 1100 may further include, at 1108, receiving DCI with a 3-bit value in a TCI codepoint field to indicate a first TCI codepoint.

The operation flow/algorithmic structure 1100 may further include, at 1112, processing an uplink or downlink transmission based on one or more TCI states associated with the first TCI codepoint. In particular, the UE may adjust its transmit or receive beams based on the one or more TCI states.

In some embodiments, the DCI may include an application field to provide a further indication of which TCI states are to be used to update a configuration of a UE. For example, the application field may be a 4-bit field that includes a bitmap that provides an indication of whether each of the four TCI states are to be used to update a respective TCI state of the UE. For another example, the application field may be a 2-bit field with each of the bits providing an indication of whether one or more associated TCI updates are to be used to update respective TCI states of the UE. For example, the associations of the bits to the respective TCI states may be consistent with the mappings of Table 1 and Table 2.

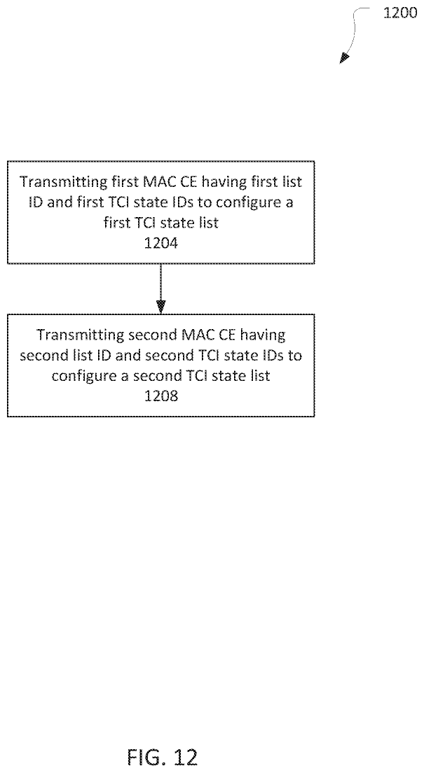

FIG. 12 is an operation flow/algorithmic structure 1200 in accordance with some embodiments. The operation flow/algorithmic structure 1200 may be implemented by base station such as, for example, base station 108 or network node 1500 or components therein, for example, processors 1504.

The operation flow/algorithmic structure 1200 may include, at 1204, transmitting a first MAC CE having a first list ID and first TCI state IDs to configure a first TCI-state list. The first list ID may be a one bit value that indicates whether the list corresponds to a first TRP or a second TRP.

The operation flow/algorithmic structure 1200 may further include, at 1208, transmitting a second MAC CE having a second list ID and second TCI state IDs to configure a second TCI-state list. The second list ID may be a one bit value that indicates whether the list corresponds to the first TRP or the second TRP, whichever complements the first ID list.

After the first and second TCI-state lists are configured, thereafter the base station may indicate specific TCI states using DCI with a TCI codepoint value that corresponds to one or more of the lists. In some embodiments, the DCI may include a plurality of TCI codepoint fields. In other embodiments, the DCI may include one TCI codepoint field and additional information to indicate whether the TCI codepoint field corresponds to the first list, the second list, or both the first and second lists.

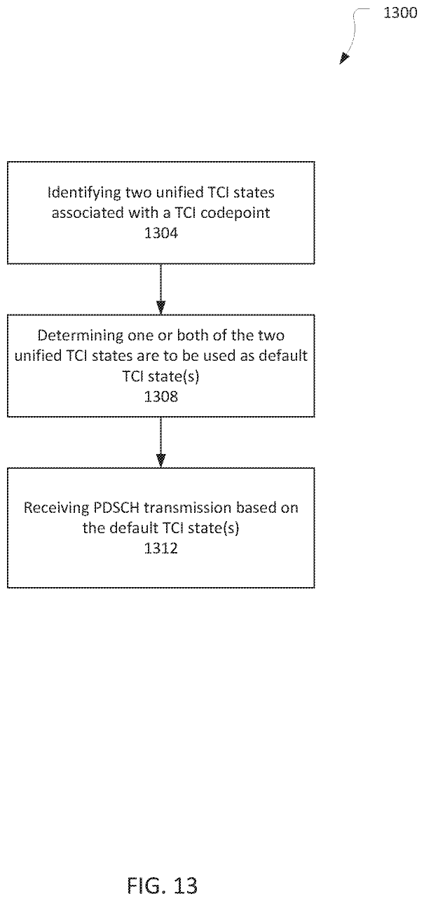

FIG. 13 is an operation flow/algorithmic structure 1300 in accordance with some embodiments. The operation flow/algorithmic structure 1300 may be implemented by a UE, for example, UE 104 or 1400 or components therein, for example, processors 1404.

The operation flow/algorithmic structure 1300 may include, at 1304, identifying two unified TCI states associated with a TCI codepoint.

The operation flow/algorithmic structure 1300 may further include, at 1308, determining one or both of the two unified TCI states are to be used as default TCI state(s). In some embodiments, determining at 1308 may be based on an RRC parameter in a CORESET/PDSCH configuration that provides an explicit indication of which TCI state(s) are to be used as the default TCI state(s). In other embodiments, the default TCI state(s) may be set to the TCI state(s) that the UE uses to monitor for PDCCH transmissions. In still other embodiments, the default TCI state(s) for a first PDSCH transmission may be set to TCI state(s) indicated in a DCI used to schedule a second PDSCH transmission that occurred prior to the first PDSCH transmission.

The operation flow/algorithmic structure 1300 may further include, at 1312, receiving a PDSCH transmission based on the default TCI state(s). In some embodiments, the default TCI state(s) may be used for PDSCH transmissions when a time offset bet okay ween the scheduling DCI and the scheduled PDSCH transmission is less than time DurationforOCL. In other embodiments, the default TCI state(s) may be used for PDSCH transmissions that are not specifically scheduled by a DCI (for example, semi-persistently scheduled PDSCH transmissions) or are scheduled by a DCI that does not include TCI codepoint value.

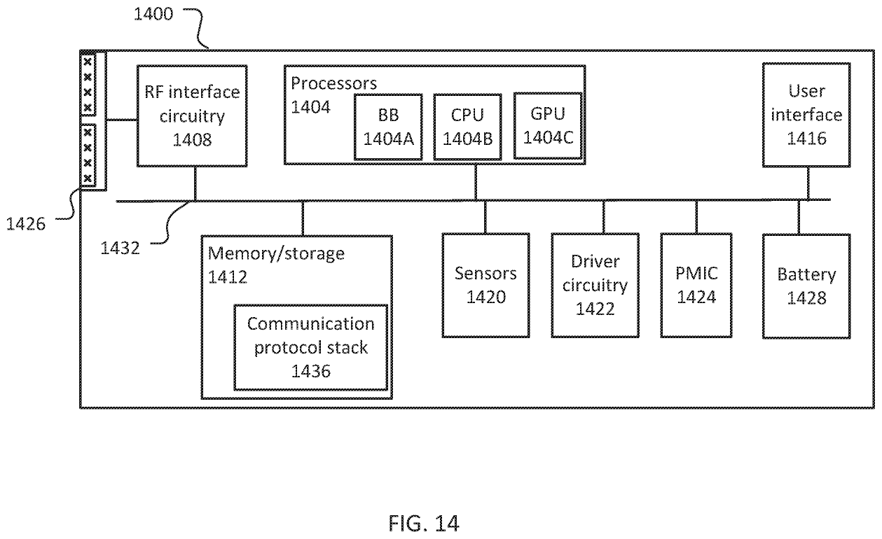

FIG. 14 illustrates a UE 1400 in accordance with some embodiments. The UE 1400 may be similar to and substantially interchangeable with UE 104 of FIG. 1.

The UE 1400 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, or optical connection that allows various circuit components (on common or different chips or chipsets) to interact with one another.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack 1436 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various operations described herein. The memory/storage 1412 include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology. The memory/storage 1412 may include a subscriber identity module (SIM)/universal subscriber identity module (USIM) in some embodiments.

In some embodiments, the UE 1400 may include a universal integrated circuit card (UICC) that is removably coupled with platform circuitry of the UE 1400 through, for example, a card slot. The UICC may include portions of the processors 1404 and memory/storage 1412 and may include the SIM/USIM. In other embodiments, the components of the UICC may be integrated directly into (e.g., permanently coupled with) the platform circuitry of the UE 1400.

The RF interface circuitry 1408 may include transceiver circuitry and radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1426.

In various embodiments, the RF interface circuitry 1408 may be configured to transmit/receive signals in a manner compatible with NR access technologies.

The antenna structure 1426 may include antenna elements to convert electrical signals into radio waves to travel through the air and to convert received radio waves into electrical signals. The antenna elements may be arranged into one or more antenna panels. The antenna structure 1426 may have antenna panels that are omnidirectional, directional, or a combination thereof to enable beamforming and multiple input, multiple output communications. The antenna structure 1426 may include microstrip antennas, printed antennas fabricated on the surface of one or more printed circuit boards, patch antennas, or phased array antennas. The antenna structure 1426 may have one or more panels designed for specific frequency bands including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various I/O) devices that may be present within, or connected to, the UE 1400. For example, the driver circuitry 1422 may include circuitry to facilitate coupling of a UICC (for example, UICC 148) to the UE 1400. For additional examples, driver circuitry 1422 may include a display driver to control and allow access to a display device, a touchscreen driver to control and allow access to a touchscreen interface, sensor drivers to obtain sensor readings of sensors 1420 and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400 including DRX as discussed herein.

A battery 1428 may power the UE 1400, although in some examples the UE 1400 may be mounted deployed in a fixed location, and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

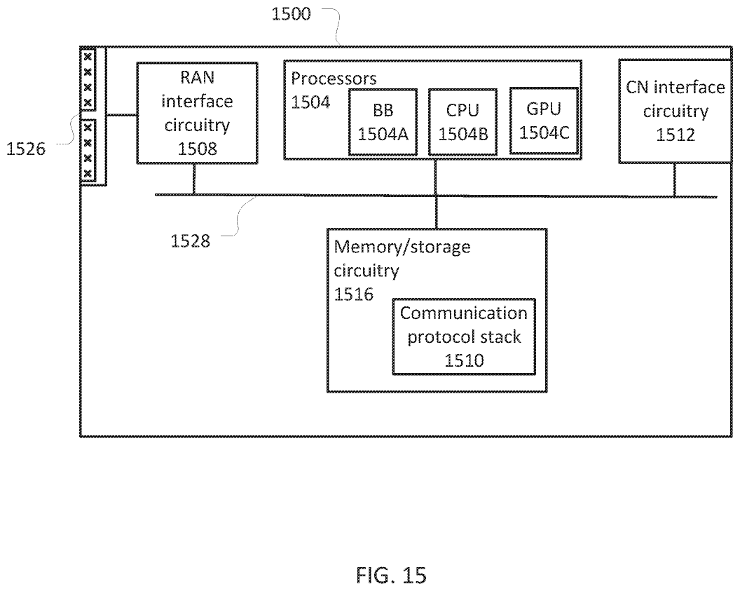

FIG. 15 illustrates a network node 1500 in accordance with some embodiments. The network node 1500 may be similar to and substantially interchangeable with base station 108, a device implementing one of the network hops 154, an IAB node, a network-controlled repeater, or a server in a core network or external data network.

The network node 1500 may include processors 1504, RF interface circuitry 1508 (if implemented as an access node), core network (CN) interface circuitry 1512, memory/storage circuitry 1516, and antenna structure 1526.

The components of the network node 1500 may be coupled with various other components over one or more interconnects 1528.

The processors 1504, RF interface circuitry 1508, memory/storage circuitry 1516 (including communication protocol stack 1510), antenna structure 1526, and interconnects 1528 may be similar to like-named elements shown and described with respect to FIG. 14.

The CN interface circuitry 1512 may provide connectivity to a core network, for example, a 5th Generation Core network (5GC) using a 5GC-compatible network interface protocol such as carrier Ethernet protocols, or some other suitable protocol. Network connectivity may be provided to/from the network node 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

In some embodiments, the network node 1500 may be coupled with transmit receive points (TRPs) using the antenna structure 1526, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary aspects are provided.

Example 1 includes a method comprising: receiving information to associate eight TCI codepoints with respective combinations of four TCI states; receiving downlink control information (DCI) having a three-bit value in a transmission configuration indicator (TCI) codepoint field to indicate a first TCI codepoint of the eight TCI codepoints, wherein the first TCI codepoints is configured with a first combination of four TCI states; and processing an uplink or downlink transmission based on one or more TCI states from the first combination of four TCI states.

Example 2 includes the method of example 1 or some other example herein, wherein the first combination of four TCI states includes a first TCI state, a second TCI state, a third TCI state, and a fourth TCI state, the DCI further includes a four-bit value in an application field, and the method further comprises: determining whether to update a first downlink TCI state to the first TCI state based on a first bit of the four-bit value; determining whether to update a first uplink TCI state to the second TCI state based on a second bit of the four-bit value; determining whether to update a second downlink TCI state to the third TCI state based on a third bit of the four-bit value; and determining whether to update a second uplink TCI state to the fourth TCI state based on a fourth bit of the four-bit value.

Example 3 includes the method of example 1 or some other example herein, wherein the DCI further includes a two-bit value in an application field and the method further comprises: determining whether to update a first downlink TCI state to a first TCI state of the four TCI states and whether to update a second downlink TCI state to a second TCI state of the four TCI states based on a first bit of the two-bit value; and determining whether to update a first uplink TCI state to a third TCI state of the four TCI states and whether to update a second uplink TCI state to a fourth TCI state of the four TCI states based on a second bit of the two-bit value.

Example 4 includes a method of example 1 or some other example herein, wherein the DCI further includes a two-bit value in an application field and the method further comprises: determining whether to update a first downlink TCI state to a first TCI state of the four TCI states and whether to update a first uplink TCI state to a second TCI state of the four TCI states based on a first bit of the two-bit value; and determining whether to update a second downlink TCI state to a third TCI state of the four TCI states and whether to update a second uplink TCI state to a fourth TCI state of the four TCI states based on a second bit of the two-bit value.

Example 5 includes a method comprising: receiving a first media access control (MAC) control element (CE) having a first list identifier (ID) and a first plurality of transmission configuration indicator (TCI) state identifiers; and receiving a second MAC CE having a second list ID and a second plurality of TCI state identifiers; configuring a first TCI-state list based on the first MAC CE; and configuring a second TCI-state list based on the second MAC CE.

Example 6 includes the method of example 5 or some other example herein, wherein the method further comprises: receiving a downlink control information (DCI) having a first three-bit value in a first TCI codepoint field and a second three-bit value in a second TCI codepoint field; and identifying first one or more TCI states from the first TCI-state list based on the first three-bit value; and identifying second one or more TCI states from the second TCI-state list based on the second three-bit value.

Example 7 includes a method of example 6 or some other example herein, wherein the DCI comprises DCI format 1_1 or DCI format 1_2 with or without data scheduling.

Example 8 includes the method of example 5 or some other example herein, wherein the method further comprises: receiving a downlink control information (DCI) having a first value in a set field and a second value in a TCI codepoint field, wherein the first value is a one-bit or two-bit value and the second value is a three-bit value; and selecting one or more indicated lists from the first TCI-state list and the second TCI-state list based on the first value; and identifying at least one TCI state from the one or more indicated lists based on the three-bit value.

Example 9 includes a method of example 8 or some other example herein, wherein the first value is a one-bit value, said selecting comprises selecting one indicated list from the first TCI-state list and the second TCI-state list based on the first value, and said identifying the at least one TCI state comprises identifying at least one TCI state from the one indicated list.

Example 10 includes the method of example 8 or some other example herein, wherein the first value is a two-bit value, and said selecting the one or more indicated lists comprises: determining whether the first TCI-state list is included in the one or more indicated lists based on a first bit of the two-bit value; and determining whether the second TCI-state list is included in the one or more indicated lists based on a second bit of the two-bit value.

Example 11 includes the method of example 5 or some other example herein, wherein the first list ID is associated with a first transmit-receive point (TRP) and the second list ID is associated with a second TRP.

Example 12 includes a method comprising: transmitting a first media access control (MAC) control element (CE) having a first list identifier (ID) and a first plurality of transmission configuration indicator (TCI) state identifiers to configure a first TCI-state list; and transmitting a second MAC CE having a second list ID and a second plurality of TCI state identifiers to configure a second TCI-state list.

Example 13 includes the method of example 12 or some other example herein, wherein the method further comprises: transmitting a downlink control information (DCI) having a first three-bit value in a first TCI codepoint field and a second three-bit value in a second TCI codepoint field, wherein the first three-bit value is to identify first one or more TCI states from the first TCI-state and the second three-bit value is to identify second one or more TCI states from the second TCI-state list.

Example 14 includes the method of example 13 or some other example herein, wherein the DCI comprises DCI format 1_1 or DCI format 1_2 with or without data scheduling.

Example 15 includes a method comprising: identifying two unified downlink transmission configuration indicator (TCI) states associated with a TCI codepoint; determining one or both of the two unified downlink TCI states are to be used as default TCI state(s); and receiving a physical downlink shared channel (PDSCH) transmission based on the default TCI state(s).

Example 16 includes the method of example 15 or some other example herein, further comprising: receiving a radio resource control (RRC) parameter in a control resource set (CORESET) configuration or a PDSCH configuration; and determining one or both of the two unified downlink TCI states are to be used as default TCI state(s) based on the RRC parameter.

Example 17 includes the method of example 16 or some other example herein, further comprising: receiving downlink control information (DCI) to schedule the PDSCH transmission; and receiving the PDSCH transmission based on the default TCI state(s) configured by the RRC parameter.

Example 18 includes the method of example 15 or some other example herein, further comprising: receiving downlink control information (DCI) to schedule the PDSCH transmission; and receiving the PDSCH transmission based on the default TCI state(s) based on a determination that a time between receiving the DCI and receiving the PDSCH transmission is less than a predetermined threshold.

Example 19 includes the method of example 18 or some other example herein, further comprising: transmitting, in a UE capability report, an indication of the predetermined threshold.

Example 20 includes the method of example 19 or some other example herein, wherein the predetermined threshold is associated with a subcarrier spacing (SCS).

Example 21 includes the method of example 15 or some other example herein, further comprising: determining a quasi-co-location (QCL) assumption of a lowest control resource set (CORESET) identity (ID); and determining one or both of the two unified downlink TCI states are to be used as default TCI state(s) based on the QCL assumption of the lowest CORESET identity.

Example 22 includes the method of example 15 or some other example herein, further comprising: receiving an instruction in a radio resource control (RRC) signal; and determining, based on the instruction, whether a first mode or a second mode is to be used in determining the default TCI state(s), wherein the first mode is based on an RRC parameter in a control resource set (CORESET) configuration or a PDSCH configuration and the second mode is based on one or more TCI states used to monitor a control resource set (CORESET).

Example 23 includes a method of example 15 or some other example herein, wherein the PDSCH transmission is a first PDSCH transmission and the method further comprises: receiving a downlink control information (DCI) to schedule a second PDSCH transmission, the DCI to include a TCI codepoint field to indicate one or both of the two unified downlink TCI states; and determining one or both of the two unified downlink TCI states are to be used as default TCI state(s) based on the TCI codepoint field, wherein the first PDSCH transmission is to occur after the second PDSCH transmission.

Example 24 includes a method of example 23 or some other example herein, further comprising: receiving the first PDSCH transmission after a time period that is greater than a time duration for quasi-colocation (QCL) from receiving the DCI

Another example may include one or more non-transitory computer-readable media comprising instructions to cause an electronic device, upon execution of the instructions by one or more processors of the electronic device, to perform one or more elements of a method described in or related to any of examples 1-23, or any other method or process described herein.

Another example may include an apparatus comprising logic, modules, or circuitry to perform one or more elements of a method described in or related to any of examples 1-23, or any other method or process described herein.

Another example may include a method, technique, or process as described in or related to any of examples 1-23, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-23, or portions thereof.

Another example include a signal as described in or related to any of examples 1-23, or portions or parts thereof.

Another example may include a datagram, information element, packet, frame, segment, PDU, or message as described in or related to any of examples 1-23, or portions or parts thereof, or otherwise described in the present disclosure.

Another example may include a signal encoded with data as described in or related to any of examples 1-23, or portions or parts thereof, or otherwise described in the present disclosure.

Another example may include a signal encoded with a datagram, IE, packet, frame, segment, PDU, or message as described in or related to any of examples 1-23, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-23, or portions thereof.

Another example may include a computer program comprising instructions, wherein execution of the program by a processing element is to cause the processing element to carry out the method, techniques, or process as described in or related to any of examples 1-23, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-24. (canceled)

25. One or more non-transitory, computer-readable media having instructions that, when executed, cause processor circuitry to:
receive information to associate eight TCI codepoints with respective combinations of four TCI states;
receive downlink control information (DCI) having a three-bit value in a transmission configuration indicator (TCI) codepoint field to indicate a first TCI codepoint of the eight TCI codepoints, wherein the first TCI codepoints is configured with a first combination of four TCI states; and
process an uplink or downlink transmission based on one or more TCI states from the first combination of four TCI states.

26. The one or more non-transitory, computer-readable media of claim 25, wherein the first combination of four TCI states includes a first TCI state, a second TCI state, a third TCI state, and a fourth TCI state, the DCI further includes a four-bit value in an application field, and the instructions, when executed, further cause the processor circuitry to:
determine whether to update a first downlink TCI state to the first TCI state based on a first bit of the four-bit value;
determine whether to update a first uplink TCI state to the second TCI state based on a second bit of the four-bit value;
determine whether to update a second downlink TCI state to the third TCI state based on a third bit of the four-bit value; and
determine whether to update a second uplink TCI state to the fourth TCI state based on a fourth bit of the four-bit value.

27. The one or more non-transitory, computer-readable media of claim 25, wherein the DCI further includes a two-bit value in an application field and the instructions, when executed, further cause the processor circuitry to:
determine whether to update a first downlink TCI state to a first TCI state of the four TCI states and whether to update a second downlink TCI state to a second TCI state of the four TCI states based on a first bit of the two-bit value; and
determine whether to update a first uplink TCI state to a third TCI state of the four TCI states and whether to update a second uplink TCI state to a fourth TCI state of the four TCI states based on a second bit of the two-bit value.

28. The one or more non-transitory, computer-readable media of claim 25, wherein the DCI further includes a two-bit value in an application field and the instructions, when executed, cause the processor circuitry to:
determine whether to update a first downlink TCI state to a first TCI state of the four TCI states and whether to update a first uplink TCI state to a second TCI state of the four TCI states based on a first bit of the two-bit value; and
determine whether to update a second downlink TCI state to a third TCI state of the four TCI states and whether to update a second uplink TCI state to a fourth TCI state of the four TCI states based on a second bit of the two-bit value.

29. A method comprising:
generating a first media access control (MAC) control element (CE) having a first list identifier (ID) and a first plurality of transmission configuration indicator (TCI) state identifiers to configure a first TCI-state list; and
generating a second MAC CE having a second list ID and a second plurality of TCI state identifiers to configure a second TCI-state list.

30. The method of claim 29, wherein the method further comprises:
generating downlink control information (DCI) having a first three-bit value in a first TCI codepoint field and a second three-bit value in a second TCI codepoint field,
wherein the first three-bit value is to identify first one or more TCI states from the first TCI-state list and the second three-bit value is to identify second one or more TCI states from the second TCI-state list.

31. The method of claim 30, wherein the DCI comprises DCI format 1_1 or DCI format 1_2 with or without data scheduling.

32. The method of claim 29, wherein the method further comprises:
generating downlink control information (DCI) having a first value that is to indicate a list from the first TCI-state list or the second TCI-state list and a second value that is to identify at least one TCI state from the list.

33. The method of claim 29, wherein the first list ID is associated with a first transmit-receive point (TRP) and the second list ID is associated with a second TRP.

34. A method comprising:
identifying two unified downlink transmission configuration indicator (TCI) states associated with a TCI codepoint;
determining one or both of the two unified downlink TCI states are to be used as default TCI state(s); and
receiving a physical downlink shared channel (PDSCH) transmission based on the default TCI state(s).

35. The method of claim 34, further comprising:
receiving a radio resource control (RRC) parameter in a control resource set (CORESET) configuration or a PDSCH configuration; and
determining one or both of the two unified downlink TCI states are to be used as default TCI state(s) based on the RRC parameter.

36. The method of claim 35, further comprising:
receiving downlink control information (DCI) to schedule the PDSCH transmission; and
receiving the PDSCH transmission based on the default TCI state(s) configured by the RRC parameter.

37. The method of claim 34, further comprising:
receiving downlink control information (DCI) to schedule the PDSCH transmission; and
receiving the PDSCH transmission based on the default TCI state(s) based on a determination that a time between receiving the DCI and receiving the PDSCH transmission is less than a predetermined threshold.

38. The method of claim 37, further comprising:
generating a UE capability report with an indication of the predetermined threshold.

39. The method of claim 38, wherein the predetermined threshold is associated with a subcarrier spacing (SCS).

40. The method of claim 34, further comprising:
determining a quasi-co-location (QCL) assumption of a lowest control resource set (CORESET) identity (ID); and
determining one or both of the two unified downlink TCI states are to be used as default TCI state(s) based on the QCL assumption of the lowest CORESET identity.

41. The method of claim 34, further comprising:
receiving an instruction in a radio resource control (RRC) signal; and
determining, based on the instruction, whether a first mode or a second mode is to be used in determining the default TCI state(s),
wherein the first mode is based on an RRC parameter in a control resource set (CORESET) configuration or a PDSCH configuration and the second mode is based on one or more TCI states used to monitor a control resource set (CORESET).

42. The method of claim 34, wherein the PDSCH transmission is a first PDSCH transmission and the method further comprises:
receiving a downlink control information (DCI) to schedule a second PDSCH transmission, the DCI to include a TCI codepoint field to indicate one or both of the two unified downlink TCI states; and
determining one or both of the two unified downlink TCI states are to be used as default TCI state(s) based on the TCI codepoint field.

43. The method of claim 42, wherein the first PDSCH transmission is to occur after the second PDSCH transmission.

44. The method of claim 42, further comprising:
receiving the first PDSCH transmission after a time period that is greater than a time duration for quasi-colocation (QCL) from receiving the DCI.
